(19) United States
(12) Patent Application Publication
(10) Pub. No.: US 2010/0217814 A1
(43) Pub. Date: Aug. 26, 2010

(54) APPARATUS AND METHOD FOR ENABLING NETWORK-COMPATIBLE CAMERAS TO OPERATE IN INSTANT MESSAGING NETWORKS

(76) Inventor: Bert Strueber, Seelze (DE)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/707,627

(22) Filed: Feb. 17, 2010

Related U.S. Application Data
(60) Provisional application No. 61/153,563, filed on Feb. 18, 2009.

(51) Int. Cl. G06F 15/16

(52) U.S. Cl. 709/206; 709/231

(57) ABSTRACT

The invention relates to an apparatus including a first processing module that is configured to provide data, a network services module, an instant messaging module including a streaming module integrated in the instant messaging module, and an instant messaging controller. The instant messaging module is configured to support execution of a first instant messaging client. The streaming module is configured to process the data to generate processed data and to send the processed data to the network services module in response to the instant messaging controller. The instant messaging controller is configured to control the instant messaging module. The first instant messaging client is configured to log on to an instant messaging service, log off from the instant messaging service, exchange information with the instant messaging service, and transmit the processed data via the instant messaging service.

### RELATED APPLICATIONS

This is a NONPROVISIONAL of and hereby claims the priority benefit of U.S. Provisional Patent Application No. 61/153,563, filed 18 Feb. 2009, which is incorporated herein by reference.

### FIELD OF THE INVENTION

The invention relates generally to electronic devices that send and/or receive image data, video data, and/or audio data. More particularly, the invention relates to a network-compatible camera but not exclusively to cameras.

### BACKGROUND

Network-compatible cameras are electronic devices that may include one or more sensors that capture visual information, and that may transfer this information via a computer network as a series of images and/or video. Nowadays, network-compatible cameras are used in a multitude of ways, such as, as a webcam for objects of interest and for indoor and outdoor monitoring of property.

Network-compatible cameras can be addressed by participants within a computer network. The participants can establish a connection to the camera, have video data sent to them, and disconnect from the connection. In addition, the participants in the computer network can change the configuration of the camera.

Network-compatible cameras are typically installed in a local Internet Protocol (IP) network. The users' applications are often located in another local computer network. The Internet can be reached from both local computer networks. However, the participants of the local computer network typically are not directly accessible from the Internet and therefore also typically are not directly accessible from another local computer network that is connected to the Internet.

In order to reach a camera associated with one computer network from a computer systems associated with another computer network, one approach is to configure the two networks to establish connectivity there-between. To perform this configuration, the requisite technical know-how and access to the configuring components of the computer networks are generally needed.

Another approach is to set up a server that can be reached from the Internet and also from the various computer networks. The network-compatible cameras from different computer networks and all users and/or user applications from other networks communicate with the server. The server thus acts as an intermediary between various users and cameras. This process generally requires a special server.

Readers may find it instructive to refer to the following patent applications, the contents of which are incorporated by reference: (I) EP 1 311 123 B1 (DE 602 24 866 T2). “Controlling a video camera”; and (2) EP 1 137 285 A1, “Remote control camera and method of operating the same.”

### SUMMARY OF THE INVENTION

In one embodiment, an apparatus includes a first processing module that is configured to provide data, a network services module, an instant messaging module including a streaming module integrated in the instant messaging module, and an instant messaging controller. The instant messaging module is configured to support execution of a first instant messaging client. The streaming module is configured to process the data to generate processed data, and to send the processed data to the network services module in response to the instant messaging controller. The instant messaging controller is configured to control the instant messaging module. The first instant messaging client is configured to log on to an instant messaging service, log off from the instant messaging service, exchange information with the instant messaging service, and transmit the processed data via the instant messaging service.

### BRIEF DESCRIPTION OF THE DRAWINGS

The present invention is illustrated by way of example, but not limitation, in the figures of the accompanying drawings, in which:

FIG. 1 illustrates an apparatus that enables a network-compatible camera to operate in an instant messaging network, in accordance with one embodiment of the present invention;

FIG. 2 illustrates an exchange of video and/or audio data via an instant messaging server, in accordance with one embodiment of the present invention;

FIG. 3 illustrates an exchange of video and/or audio data via a separate server or computer, in accordance with one embodiment of the present invention; and

FIG. 4 illustrates a direct exchange of video and/or audio data between two instant messaging clients, in accordance with one embodiment of the present invention.

### DETAILED DESCRIPTION

Described herein are improvements for network-compatible cameras that allow such cameras to exchange communications directly with users thereof, without having to resort to specialized network connectivity configurations or intermediary servers. In one embodiment, network-compatible cameras configured in accordance with the present invention operate in (e.g., may be integrated into) instant messaging networks. Such network-compatible cameras can be reached from the Internet and from local computer networks without use of special servers.

Embodiments of the invention provide an apparatus that includes a first processing module that is configured to provide data; a network services module; an instant messaging module including a streaming module integrated in the instant messaging module, wherein the instant messaging module is configured to support execution of a first instant messaging client; and an instant messaging controller. The streaming module is configured to process the data to generate processed data, and to send the processed data to the network services module in response to the instant messaging controller; the instant messaging controller is configured to control the instant messaging module; and the first instant messaging client is configured to log on to an instant messaging service, log off from the instant messaging service, exchange information with the instant messaging service, and transmit the processed data via the instant messaging service.

The processed data may include image, video, and/or audio data, and the first processing module may include an image processing module, a video processing module, and/or an audio processing module. The first instant messaging client may be configured to exchange information directly with a second instant messaging client, for example by transmitting the processed data and/or receiving image, video, and/or audio data. Further, the first instant messaging client may be configured to exchange information with an instant messaging server, for example by transmitting the processed data and/or receiving image, video, and/or audio data.

The apparatus may be configured to exchange information via at least one computer, for example by transmitting the image, video, and/or audio data to the at least one computer, and the at least one computer may transmit the data to the second instant messaging client. Likewise, the apparatus may be configured to receive the image, video, and/or audio data from the at least one computer, and the at least one computer receive the data from the second instant messaging client of the user. The at least one computer may include at least two computers in a chain.

The apparatus may include a camera control module in addition to or instead of the first processing module, and may be configured to transmit camera control information (e.g., information obtained from key buttons and sensors of the apparatus), and to be controlled via the first instant messaging client. The apparatus may further include a replay module and a second processing module, wherein the apparatus is configured to receive image, video, and/or audio data, process the image, video, and/or audio data in the second processing module, and render the image, video, and/or audio data using the replay module.

The apparatus need not include an audio processing module, but may be configured to transmit audio data created from an external source or from pre-defined information in the memory of the device. Further, the apparatus may be configured to exchange image, video, and/or audio data with several instant messaging clients simultaneously and thereby manage and control several connections, and/or to send image, video, and/or audio data to a computer in order to be saved on the computer. The data transfer to the computer (or elsewhere) can be actuated through configuration or by an event (e.g., a preset event, an event defined through configuration by a user, the content of a video image, the detection of a movement or a face, or an audio signal). The apparatus may also be configured to exchange configuration information or other information or messages with a second instant messaging client, and to allow the configuration information to be set and retrieved by the second instant messaging client.

In varying embodiments, an apparatus configured according to the present invention may be configured to exchange image, video, and/or audio data based on a trigger received from a second instant messaging client; establish transmission of the image, video, and/or audio data to an application via the second instant messaging client based on a first event or a first time value at the apparatus; transmit the image, video, and/or audio data to the application via the second instant messaging client; and control and/or end the transmission based on a second event or a second time value at the apparatus. The second instant messaging client may exert control over the apparatus through commands that are sent to the apparatus, which may react to the commands by returning information. Among such commands may be commands to modify the rotation and pitch of the apparatus and the sharpness setting and the zoom of a lens of the apparatus, etc. Communications with the second messaging client may be direct, via broadcast or multicast or via exchange services independent of a server.

Still further apparatus configured according to embodiments of the invention may include a second processing module that includes an audio and video processing module. Such apparatus may transmit processed data (e.g., image, video, and/or audio data) to the audio and video processing module or elsewhere. Various sizes of images, video, and/or audio data may be resized prior to transmission. Of course, the apparatus may be configured and/or operated exclusively in an instant messaging network, or may be operated in combination with other services and networks.

Instant messaging enables users to exchange information quickly. Instant messaging networks usually include at least one instant messaging server and several instant messaging clients. The clients are typically implemented and executed as software on electronic devices and computers. During instant messaging, the users of the instant messaging client are usually also in local computer networks that cannot be reached from the Internet. Instant messaging clients may be used to exchange user text messages that are immediately delivered to the recipient. In addition, instant messaging clients may exchange further information, such as client application features, files and images, and user availability information. Client applications may also support the exchange of image, audio, and/or video data. Image, audio, and/or video data are customarily exchanged via additional protocols. The direct transmission of data from one instant messaging client to another instant messaging client usually requires additional technology that makes it possible to connect two participants from two different local networks to each other.

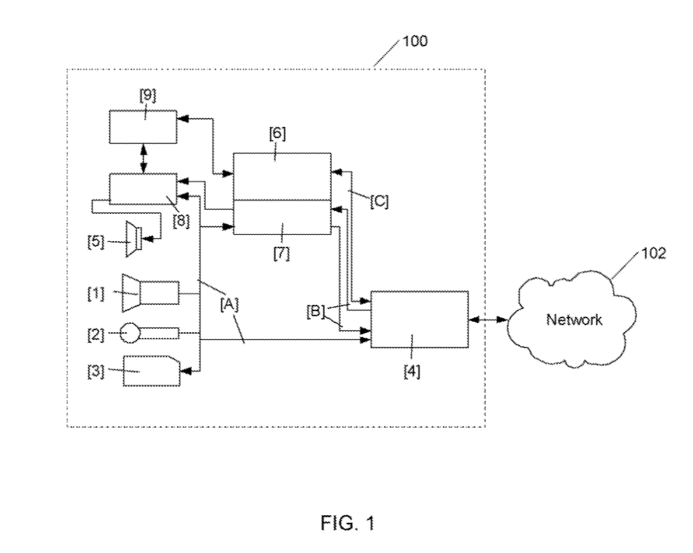

By adding an autonomously functioning instant messaging client and expanding the functionality of the instant messaging client to operate the computer network-compatible camera, the set-up of a special server and the special configuration of the local computer network are no longer needed. In one embodiment of the present invention, an instant messaging controller (see FIG. 1) that enables an instant messaging client to function autonomously is integrated in a network-compatible camera (thereby providing an instant messaging camera). In addition, many of the instant messaging camera's actions and reactions with integrated instant messaging clients are created by preset algorithms and by data of the integrated sensors captured on the device, e.g., image content, audio information, and information about position, vibration, or motion sensors.

FIG. 1 illustrates an apparatus that enables a network-compatible camera 100 to operate in an instant messaging network 102, in accordance with one embodiment of the present invention. The camera 100 contains various modules. Processing module [1] includes a video processing module and/or an image processing module. The processing module [1] may perform image capture. Module [4] includes a network services module. The network services module may enable communication with a computer network based on network protocols. The visual data can be collected in an analog as well as digital format depending on the version of the camera. In cameras with analog data collection, the data is converted prior to sending digital data to the processing module [1]. Often video data is compressed via a special codec prior to sending. For communication, computer networks commonly use protocols such as IP.

In another embodiment, the camera 100 includes an audio processing module [2]. The audio processing module [2] may collect additional audio data and send the audio data via module [4] and a camera control module [3]. The camera control module [3] may be for the remote control of the camera 100. It is, for example, possible to change and retrieve the horizontal and vertical alignment of the camera 100 and the zoom and focus of the lens of the camera 100 via the camera control module [3].

In another embodiment, an instant messaging module 161 is integrated into the network-compatible camera 100. The instant messaging module [6] is configured to support execution of an instant messaging client. The instant messaging module [6] includes an instant messaging streaming module [7]. An instant messaging controller [9] is configured to control the instant messaging module [6]. The instant messaging controller [9] automatically establishes communication between the camera 100 and at least one other instant messaging client, and enables the transmission of image, video, and/or audio data between the camera 100 and the at least one other instant messaging client. The instant messaging module [6] is directly connected to the network services module [4], processes the instant messaging data, and sends instant messaging data via the network services module [4].

In another embodiment, the image, audio, and/or video data [A] from the processing module [1] and/or from the audio processing module [2] are additionally sent to the streaming module [7] of the instant messaging module [6]. The streaming module [7] expands the capabilities of instant messaging module [6]. For example, the streaming module [7] can receive image, audio, and/or video data, format the data code the data, and integrate the data into the streaming protocols used by the instant messaging system. The image, audio, and/or video data processed in such a manner is delivered to the network services module [4]. The network services module [4] may exchange the data with a communication partner, such as another instant messaging client.

In another embodiment, the image, audio, and/or video data include individual images, audio data, and data of further sensors and input units, such as key buttons. The processing and transmission of this data may be possible without a video unit being present. For example, audio data can be sent when there is no audio processing module [2] the camera. Then, audio data can come from an external source that communicates with the camera. Alternatively audio data can be available within or can be calculated internally to the camera. The available or calculated audio data may not correspond with the ambient sounds surrounding the camera; however, it can contain useful additional information for the user.

In another embodiment, the camera 100 may also include a replay module [5] for image, audio, and/or video data. The camera 100 may also include an audio and video processing module [8]. If image, audio, and/or video data [B] of the instant messaging system are received by an instant messaging client, the data [B] are sent to the streaming module [7] by the network services module [4]. There the data may be converted, extracted, and transmitted to the audio and video processing module [8]. The audio and video processing module [8] can prepare the image, audio, and/or video data for replay and can transmit the data to the replay module [5].

In another embodiment, it is also possible to receive image, audio, and/or video data from the camera even if the replay module [5] and the audio and video processing module [8] are not present. In an instant messaging system, audio data and sometimes image and/or video data as well can only be sent to another instant messaging client if the sending client is also able to receive and/or process audio, image, and/or video data. In this case the streaming module [7] receives the audio, image, and/or video data and discards it.

In another embodiment, the camera 100 can have an audio and video processing module [8] (and no replay module [5]). The camera 100 may use the received data for analysis and utilization. In this manner it is possible for the user(s) of an instant messaging client to be recognized via an image recognition and/or voice recognition by the audio and video processing unit 181. This information can then be used to enable access control to the camera. Depending on the camera's settings, this access control can be applied to set up of an audio and/or video connection, or to changes of camera configuration. The access control may also be applied to set up other users. The other users may be given access that is unlimited as to time or temporary. The access control may also be used to also revoke the access of the other users.

In another embodiment, the audio and video processing unit 181 performs integrated image, video, and/or audio analysis. This analysis is utilized to analyze the image, audio, and/or video data of the processing unit [1] and the audio processing unit [2] of the camera 100. In this manner, it is possible for the camera to recognize movement in the visual field and identify sound and establish an audio and/or video connection to an instant messaging client of a user based on this information.

In another embodiment, the audio and/or video connection need not be established based on the image, audio, and/or video data. Other events, such as a point in time or information from sensors or key buttons, can result in a connection or messaging.

It can also be desirable that the camera not establish an audio and/or video connection automatically but instead alerts another instant messaging client via an instant message about the event that has occurred. The user of the instant messaging client can then decide if he would like to establish an audio and/or video connection. More than one instant messaging clients can be notified.

The audio and video processing module [8] can expand the audio and/or video data by providing additional information. For instance, a time stamp and the name of the camera can be shown in the video image. It is also possible to reduce the audio and video information. It is, for example, possible to remove background sounds in the audio data.

In another embodiment, the camera 100 need not be exclusively designed for communication with a single instant messaging client. It is also possible for the camera to communicate with several instant messaging clients simultaneously.

Many network-compatible cameras are able to send audio and/or video data to another computer in order to record the audio and video data on the computer. For example, the camera functionality may be expanded to control the recording on a computer via the instant messaging client. It is possible for a computer to control the event that triggers a recording or the point in time of a recording and the length of the recording via the instant messaging client.

In another embodiment, the integrated instant messaging client of the camera 100 can additionally be used to configure and control the camera 100. The camera configuration can be queried, set, and modified via an instant messaging client of a user. If the camera has a camera control module [3], the camera can also be controlled via the instant messaging client of the user and the current position of the control can be queried via the instant messaging client. Controlling includes, for example, the horizontal and vertical positioning of the camera and the zoom and focus of the lens.

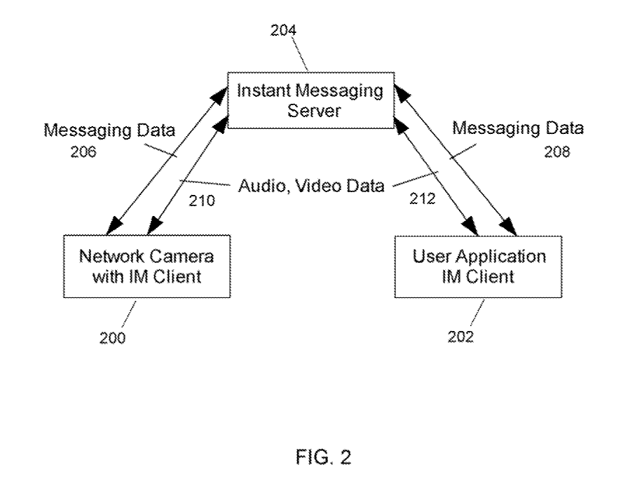

FIG. 2 illustrates an exchange of video and/or audio data via an instant messaging server 204, in accordance with one embodiment of the present invention. A network camera 200 with an instant messaging client exchanges both messaging data 206 and audio and/or video data 210 with the instant messaging server 204. A user application 202 with an instant messaging client exchanges both messaging data 208 and audio and/or video data 212 with the instant messaging server 204. The audio and/or video data 210 and 212 may include image data.

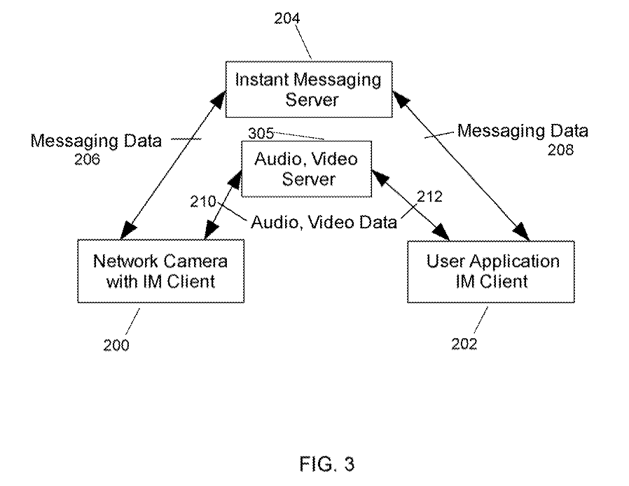

FIG. 3 illustrates an exchange of video and/or audio data via a separate server or computer 305, in accordance with one embodiment of the present invention.

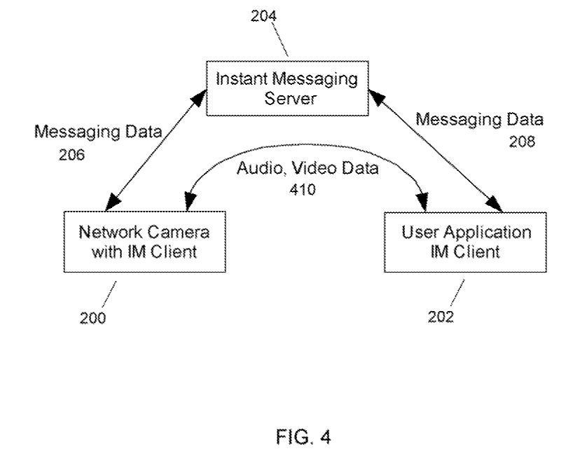

FIG. 4 illustrates a direct exchange of video and/or audio data 410 between two instant messaging clients, in accordance with one embodiment of the present invention. This may be an example of peer-to-peer communication. The direct communication between the camera 200 with integrated instant messaging client and other instant messaging clients, such as the user application 202 with an instant messaging client, can be enabled without the use of the instant messaging server 204. This method can be used in applications in which the camera and instant messaging clients are in the same local network. In one embodiment, searching in networks and transmitting between the camera 200 and the instant messaging clients 202 can be done via additional network services on the basis of multicast and/or broadcast messages.

In the configurations of any of FIGS. 2, 3, and 4, a chain of instant messaging servers and/or computers may be involved in the transmission of the data.

In another embodiment, concepts of the invention can be applied to typical intercom systems. An intercom device with an integrated instant messaging client can register at the server and wait for a reaction from the server. An instant messaging user is notified via his client when a key on the intercom device is pressed. The user can establish a connection to the intercom device. The integrated key on the intercom may be an additional sensor value on the device. The connection to transmit audio data can be established by the instant messaging client of the user. Some intercom systems can also transmit image and/or video data in addition to audio data.

An embodiment of the present invention relates to a computer-readable storage medium having computer code thereon for performing various computer-implemented operations. The media and computer code may be those specially designed and constructed for the purposes of the present invention, or they may be of the kind well known and available to those having skill in the computer software arts. Examples of computer-readable storage media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions. Computer-readable storage media do not include propagation media, carrier waves, or other transmission signals/forms of energy' that are not manufactures under 35 U.S.C. §101.

Another embodiment of the present invention may be implemented in hardware circuitry, in conjunction with or as an alternative to a computer-readable storage medium.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. An apparatus, comprising:
a first processing module that is configured to provide data;
a network services module;
an instant messaging module including a streaming module integrated in the instant messaging module, wherein the instant messaging module is configured to support execution of a first instant messaging client; and
an instant messaging controller;
wherein the streaming module is configured to process the data to generate processed data, and to send the processed data to the network services module in response to the instant messaging controller, the instant messaging controller is configured to control the instant messaging module, and the first instant messaging client is configured to log on to an instant messaging service, log off from the instant messaging service, exchange information with the instant messaging service, and transmit the processed data via the instant messaging service.

2. The apparatus of claim 1, wherein the processed data includes any of image, video, and audio data, and wherein the first processing module includes an image processing module, a video processing module, and/or an audio processing module.

3. The apparatus of claim 2, wherein the first instant messaging client is configured to exchange information directly with a second instant messaging client, wherein exchanging information includes transmitting the processed data and/or receiving image, video, and/or audio data.

4. The apparatus of claim 2, wherein the first instant messaging client is configured to exchange information with an instant messaging server, wherein exchanging information includes transmitting the processed data and/or receiving image, video, and/or audio data.

5. The apparatus of claim 2, wherein the apparatus is configured to exchange the image, video, or audio data to the at least one computer, and the at least one computer exchanges the data with the second instant messaging client.

6. The apparatus of claim 5, wherein the at least one computer includes at least two computers in a chain.

7. The apparatus of claim 1, further comprising a camera control module, wherein the apparatus is configured to transmit camera control information, and to be controlled via the first instant messaging client.

8. The apparatus of claim 7, wherein the camera control information includes information obtained from key buttons and sensors of the apparatus.

9. The apparatus of claim 7, further comprising a replay module and a second processing module, wherein the apparatus is configured to receive image, video, or audio data, process the image, video, or audio data in the second processing module, and render the image, video, or audio data using the replay module.

10. The apparatus of claim 9, wherein the apparatus is configured to transmit audio data created from an external source or from pre-defined information in a memory of the apparatus.

11. The apparatus of claim 7, wherein the apparatus is configured to exchange image, video, or audio data with several instant messaging clients simultaneously.

12. The apparatus of claim 11, wherein the apparatus is configured to transfer image, video, or audio data to a computer responsive to an event.

13. The apparatus of claim 12, wherein the event is preset.

14. The apparatus of claim 12, wherein the event is defined through configuration by a user.

15. The apparatus of claim 11, wherein the apparatus is configured to exchange configuration information with a second instant messaging client, and to allow the configuration information to be set and retrieved by the second instant messaging client.

16. The apparatus of claim 2, wherein the apparatus is configured to:
exchange the image, video, or audio data based on a trigger received from a second instant messaging client;
establish transmission of the image, video, or audio data to an application via the second instant messaging client based on a first event or a first time value at the apparatus;
transmit the image, video, or audio data to the application via the second instant messaging client; and
control the transmission based on a second event or a second time value at the apparatus.

17. The apparatus of claim 16, further comprising a second processing module, wherein the second processing module includes an audio and video processing module.

18. The apparatus of claim 1, wherein the apparatus is configured to send a message to an application in response to an event, the message requesting that a connection be established between the apparatus and the application.

19. The apparatus of claim 1, wherein the apparatus is configured to be controlled through commands that are sent from a second instant messaging client, and is configured to react to the commands by returning information to the second messaging client.

20. The apparatus of claim 1, wherein the apparatus is configured to modify any of its attitude, a sharpness setting, or a zoom setting of a lens response to commands received from an instant messaging client.
